(19) United States
(12) Patent Application Publication
(10) Pub. No.: US 2010/0284539 A1
(43) Pub. Date: Nov. 11, 2010

(54) Methods for Protecting Against Piracy of Integrated Circuits

(75) Inventors: Jarrod A. Roy, Austin, TX (US); Farinaz Koushanfar, Houston, TX (US); Igor L. Markov, Ann Arbor, MI (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignees: THE REGENTS OF THE UNIVERSITY OF MICHIGAN, Ann Arbor, MI (US); William Marsh Rice University, Houston, TX (US)

(21) Appl. No.: 12/720,634

(22) Filed: Mar. 9, 2010

Related U.S. Application Data
(60) Provisional application No. 61/158,713, filed on Mar. 9, 2009.

(51) Int. Cl. H04L 9/08; H04L 9/06; H03K 19/00

(52) U.S. Cl. 380/278; 380/46; 326/8; 380/44

(57) ABSTRACT

Techniques are provided for reducing the likelihood of piracy of integrated circuit design using combinational circuit locking system and activation protocol based on public-key cryptography. Every integrated circuit is to be activated with an external key, which can only be generated by an authenticator, such as the circuit designer. During circuit design, register transfer level (RTL) descriptions of the IC design are embedded with combinational logic based on a master key applied by the authenticator. That combinational logic renders at least one module of the RTL description locked, i.e., encrypted. The completed circuit design from the authenticator is sent to a fabrication lab with the combinationally locked modules. After fabrication, the circuit can only be activated when the authenticator sends an appropriate key that is used by the circuit to unlock the locked portions and thereby activate the circuit.

### CROSS REFERENCE TO RELATED APPLICATIONS

The present application claims the benefit of U.S. Provisional Application No. 61/158,713, entitled “Methods for Protecting Against Piracy of Integrated Circuits,” filed on Mar. 9, 2009, which is hereby incorporated by reference herein in its entirety.

### BACKGROUND OF THE INVENTION

1. Field of the Disclosure

The disclosure relates generally to integrated circuit design and, more particularly, to protecting integrated circuit designs from unauthorized piracy.

2. Brief Description of Related Technology

There is an increasing trend for semiconductor designers to use third party fabrication houses for manufacturing. LSI Logic, for example, quit semiconductor manufacturing in 2005; and Texas Instruments chose not to develop sub-45 nm fabrication in-house, instead partnering with major foundries to outsource production. In the summer of 2007, Qualcomm became the first fabless semiconductor company to rank among top 10 IC producers worldwide, and AMD has outsourced its production to foundries throughout the world.

With the growth of manufacturing potential, especially in other parts of the world, piracy has become rampant, thanks to loose intellectual property (IP) protection policies and weak enforcement. This was recently illustrated by the discovery of a “fake NEC Corp.” in China that offered 50 counterfeit products. Global piracy of hardware and software IP is now approaching $1 B per day, with a major share in computers, peripherals, and embedded systems. Indeed, once a fabrication lab (a “fab”) starts producing chips from client's masks, unauthorized copies can be made cheaply. As pointed out by the US Defense Science Board, masks can also be stolen by industrial and military spies.

The practice of hardware piracy is very different from that of software piracy because hardware cannot be cloned and because masks are much more difficult to change compared to software. The technological and financial barriers to hardware piracy are higher, but pirates tend to be better prepared, which makes countering them more challenging.

Until recently, only passive IC protection was available, based on unique chip IDs or programmable parts. Alkabani and Koushanfar [Y. Alkabani and F. Koushanfar, “Active hardware metering for intellectual property protection and security,” USENIX Security, pp. 291-306, 2007] proposed the first active scheme to fight hardware piracy by locking the chips at fabrication such that the designer is the only entity who can send the unlocking key. The method exploits the inherent unique manufacturing variability of the ICs to generate random chip IDs. The IDs are integrated within the finite state machine (FSM) which is a modified version of the original FSM in a way that every chip starts in a unique state (locked). The designer, knowing the modified FSM structure, would be the only entity who can send the key to activate (unlock) the IC. Another remote activation scheme was proposed in Y. Alkabani, F. Koushanfar, and M. Potkonjak, “Remote activation of ICs for piracy prevention and digital rights management,” IEEE/ACM ICCAD, pp. 674-677, 2007. This method relies on a set of unique chip IDs to lock the sequential and combinational structure of the circuit by locking the transitions on the FSM of the design, for pairs of consecutive transitions of a few replicated states.

### SUMMARY OF THE DISCLOSURE

The present application describes novel techniques to counteract piracy of integrated circuits. Before testing, each chip generates its own random identification number (ID) using well-known techniques. In order for a chip to become functional, the chip manufacturer must send that ID to the holder of intellectual property rights (IP holder), who then sends an activation code that only activates the chip with that ID. This allows the IP holder to control exactly how many chips are made and prevents others from making functional copies.

Various examples may provide: (i) the first purely combinational lock embedding and IC activation scheme; (ii) algorithms for embedding an authentication key into an IC, with rigorous empirical evaluation; (iii) an adaptation of the standard design flow for chip fabrication to facilitate chip activation and secure communication with negligible overhead; (iv) security guarantees; and (v) countermeasures designed to address specific types of attacks.

In some examples, a method for locking an integrated circuit, includes embedding register transfer level (RTL) descriptions for the integrated circuit design with a public master key received from an external source, wherein the RTL descriptions support the integrated circuit providing a public key and a private key pair upon start up. The method includes developing a gate-level netlist from the embedded RTL descriptions, locking at least one module of the integrated circuit in response to the gate-level netlist, and generating a common key for the at least one module and communicating the common key to the IP holder.

In some examples, a method for locking an integrated circuit comprises: embedding an operational description of the integrated circuit design with a cryptographic key supported by a cryptographic protocol, where the integrated circuit is capable of establishing a public key and a private key pair upon start up; and locking at least one module of the integrated circuit by applying to the at least one module a logical operator having a control signal input, where the logical operator is for unlocking the at least one module in response to the control signal input having a valid value and where the logical operator is for maintaining locking of the at least one module in response to the control signal input having an invalid value.

In some examples, the operational description is a register transfer level (RTL) description. In some examples, the method further includes developing a gate-level netlist from the embedded RTL description; and locking the at least one module of the integrated circuit based on the gate-level netlist.

In other examples, a method of activating at least one module on an integrated circuit, includes: the integrated circuit establishing a random public key and private key pair upon start up; transmitting the random public key to an authentication source for the integrated circuit; the authentication source sending to the integrated circuit an input key in response to receipt of the random public key, wherein the input key represents a common key for the integrated circuit and is encrypted with a private master key of the authentication source and with the received random public key; the integrated circuit decrypting the input key using the random private key and a public master key previously received at the integrated circuit to authenticate the input key as being received from a valid authentication source; and in response to the authentication of the input key, producing a common key that activates the at least one module on the integrated circuit.

### BRIEF DESCRIPTION OF THE DRAWING FIGURES

For a more complete understanding of the disclosure, reference should be made to the following detailed description and accompanying drawing figures, in which like reference numerals identify like elements in the figures, and in which:

FIG. 1 illustrates an integrated circuit that may be used to implement locking techniques in accordance with examples described herein;

FIG. 2 illustrates a flow diagram of an example integrated circuit design process in accordance with techniques described herein;

FIG. 3a illustrates an example register transfer level (RTL) description of a module within an integrated circuit, before locking, and FIG. 3b illustrates an example of the RTL description after locking with a combinational locking; and

FIG. 4 illustrates a flow diagram of an example integrated circuit activation protocol in accordance with techniques described herein.

### DETAILED DESCRIPTION

Various techniques provide protection against theft of semiconductor devices. Specifically, techniques provide for locking an integrated circuit through the insertion of logical operators into an existing circuit layout and requiring a unique key to disable those logical operators. In a batch fabrication process, each integrated circuit chip may be individually locked and require its own unique key for activation. Such activation may occur through communications between an external user and the integrated circuit over an unsecured communication channel using public-key cryptography.

An operational description of an integrated circuit (IC) (e.g., a register transfer level (RTL) description, gate-level description, or high-level description) may be modified by embedding that description with combinational locking structures, created using a master key. Modules of interest are determined, such that any number of modules of an operational description may be locked. This allows an IC to lock only desired modules. Upon locking of the modules, the IC may generate a common key and communicate that key to an authenticator, where that key may be later used in unlocking the modules through communication over the unsecured channel.

The “plaintext” used to communicate keys may be encrypted by the sender and decrypted by the receiver, using any of a number of protocols. An example encryption protocol is the Diffie-Hellman key exchange protocol, which allows for secret communications over a public network and which is an asymmetric cryptography, also known as public-key cryptography (PKC). Using this type of protocol each user independently generates a pair of keys, one public and one private. Public keys are made available to everyone, but private keys are never transmitted nor revealed by their owners. Furthermore, in preferred examples, irrespective of protocol, encryption and decryption rely on hard-to-reverse (one-way) mathematical functions, such as high-precision integer multiplication and modular exponentiation. Generally speaking, one-way functions have no efficient algorithms to compute their inverses, i.e., for number-factoring and discrete logarithm.

With the Diffie-Hellman protocol, a sender (B) encrypts plaintext with the public key of the receiver (A) and then transmits a message that can only be decrypted with A′s private key. A system proposed in 1977 by Rivest, Shamir and Adleman (RSA), enriches this public-key cryptography with a digital signature feature—if B additionally encrypts his message with his private key, then A can use B′s public key to verify that the message is unaltered and coming from B. Public-key cryptography is widely used for certificates of authenticity, generating and verifying digital signatures, and for exchanging symmetric keys that allow faster communication. RSA-style crypto-systems are among the most studied in the literature, but remain resilient against a variety of attacks 30 years after their inception.

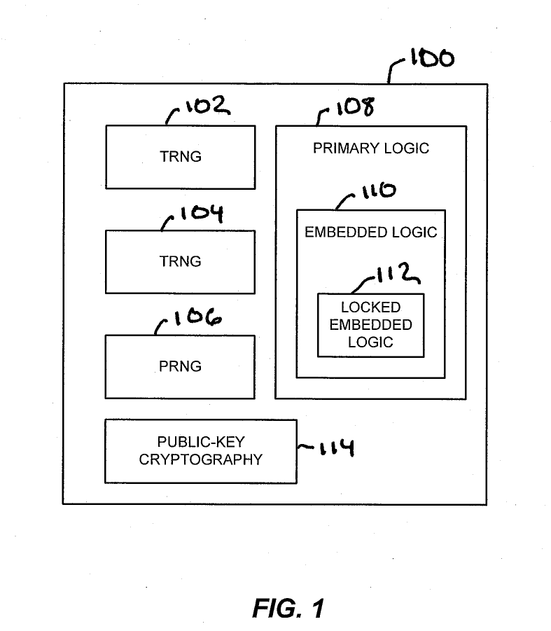

To achieve public-key cryptography, the present techniques can be used on ICs that contain true random number generators (TRNGs). FIG. 1 illustrates functional block illustration of an example IC 100 including two TRNGs 102 and 104. Randomized algorithms often use pseudo-random number generators (PRNGs), i.e., deterministic sequences with random appearance that are initiated by an input seed, one of which is shown 106 embedded in IC 100. While the PRNG 106 may be used in place of the TRNGs 102, 104, in the instant example, a truly random number generator is used. The TRNGs 102, 104 may generate true random bits, for example, by sampling chaotic physical phenomena, such as thermal noise, quantum-mechanical measurement, meta-stability in latches, etc. Such TRNGs are an important component in cryptographic applications and can be found in various commercial ICs—in other examples, they may be added to IC design. For example, the upcoming NIAGARA 2 processor from Sun Microsystems of Santa Clara, Calif. couples one TRNG in each of its eight cores having cryptographic units to support secure establishment of public and private keys.

The TRNGs 102, 104 in the illustrated example are on chip random number generators that are capable of defining randomized IC identification data (chip IDs) upon power-up. (The term “data” is generally used in a singular form in the following descriptions; yet may connote both singular datum, as well as plural data depending on the context. The term is not intended to be limiting in that regard.) In other examples, such chip IDs may be produced using on-chip variation, without a dedicated TRNG, or such chip IDs may be generated with the PRNG 106.

Manufacturing of semiconductor devices, in particular ICs can involve forming over 20 patterned layers of metals, insulators and semiconductors, with smallest feature sizes at 45 nm and decreasing. The patterns may be “burned in” by shining a 193 nm ArF laser through chromium-quartz masks in a tightly controlled process at fabrication facilities (fabs). A mask set contains a complete physical representation of an IC.

Contract fabrication houses, such as Taiwan Semiconductor Manufacturing Company Ltd. and United Microelectronics Corporation (UMC), produce masks from large computer files supplied by their clients. The IC descriptions given to such fabs are often customized to satisfy the fab's specific requirements, but if stolen, they may conceivably be adjusted to another fab, and leading-edge fabs are concerned about this.

Another form of piracy is for the contracted fab to produce more chips than authorized, at a very small additional cost, and sell them on the black market. A simple anti-piracy measure is wafer banking, i.e., contracting out different layers of a chip to different manufacturers. Not only is this expensive, but it prevents fabs from testing ICs which hampers yield analysis and improvement. Fabricating features smaller than half of 193 nm (the ArF laser's wavelength) is increasingly difficult, and no viable replacements to ArF lasers are expected in the near future. To compensate for optical diffraction, mask patterns are much more complex than the manufactured patterns and may be harder to reverse-engineer by delamination or otherwise. Physically modifying fine-grain features of ICs after manufacturing, to defeat anti-piracy measures, is very difficult. The Focused Ion Beam (FIB) technique is sometimes used to reconnect wires during post-silicon debugging, but remains too slow and expensive for mass production, and will likely be infeasible for ICs with 32 nm features.

Example techniques provided herein may address some or all of these challenges by modifying existing IC design flows through embedding keys into a semiconductor device, e.g., the IC 100, which includes a generic block indicating 108, for example, the primarily logical framework and operation of the IC 100. The logic block 108 includes non-embedded logic and a region of embedded logic 110, embedded at the RTL level as discussed herein. Within this embedded logic 110 is a smaller subset 112 of a logic, e.g., containing one or more RTL description modules, which is not only embedded, but as explained further herein has been locked (combinational locking) using an encryption key.

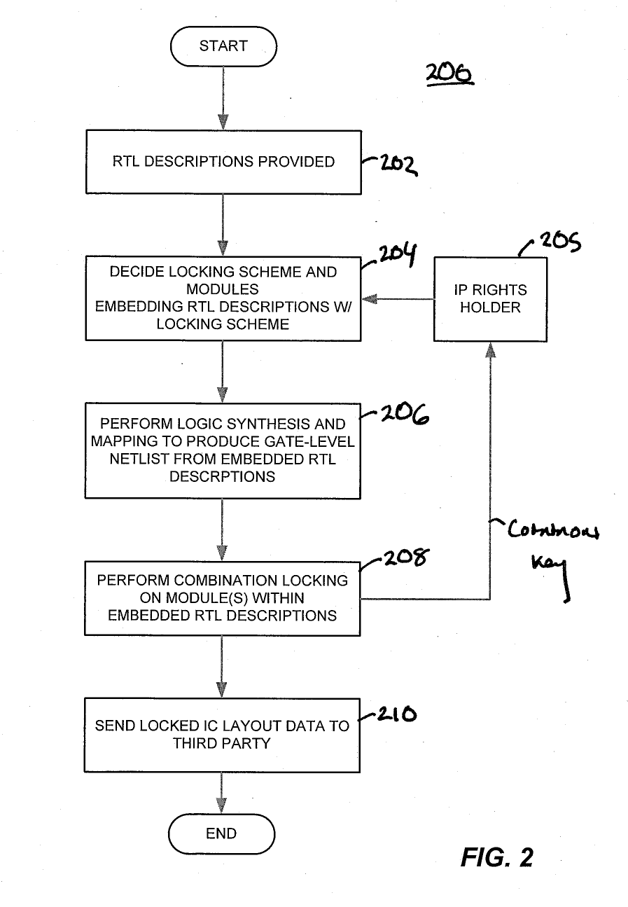

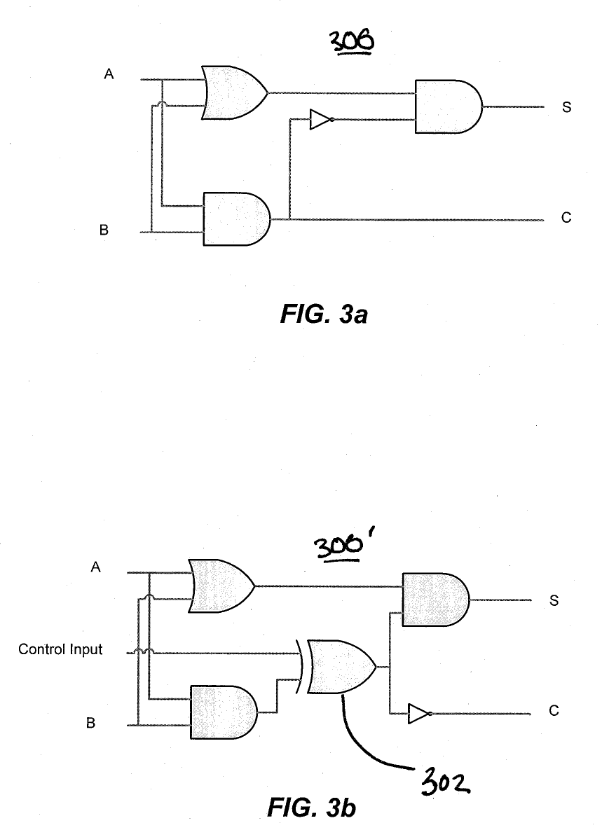

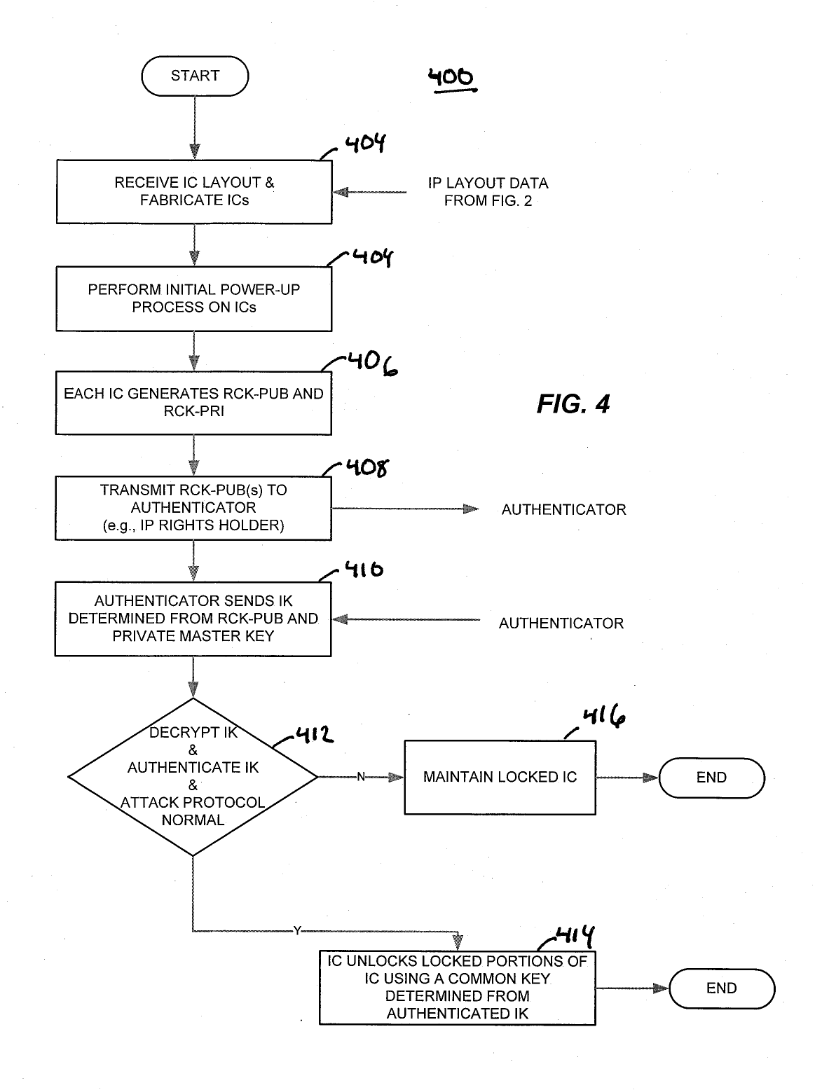

A flow diagram of the locking procedure is provide in FIG. 2, with example locking logic shown in FIGS. 3a and 3b. In addition to the locking protocols, various examples are provided for a device fabrication and activation procedure, as shown in FIG. 4. The techniques may empower the holder of intellectual property (IP) rights for the IC (e.g., the IC layout) to unlock every manufactured chip, such that without proper keys, none of the chips will function properly or pass routine circuit test.

The keys may be constructed so that different ICs even from the same wafer, may require different keys. Therefore, the key for each IC must be requested from the IP rights holder through secure communications for activation. To support public-key cryptography, the IP rights holder establishes for each chip a pair of Master Keys (MK)—public and private—that will remain unchanged. The private Master Key (MK-Pri) embodies IP rights for a given design and is never transmitted (see Table 1). This remote unlocking mechanism allows one to meter activated ICs, log serial numbers, limit activation to certain parties, only at certain rates and only at certain times of the day.

The present techniques are applicable to a broad category of semiconductor devices, including microprocessors, digital signal processing (DSP) chips, field programmable gate arrays (FPGAs), dedicated graphic chips, System-on-a-Chip devices, general-purpose and embedded microprocessors, including soft cores, network processors, game consoles, etc. The present application discusses integrated circuits (ICs) in particular. However, it will be appreciated by persons of ordinary skill in the art that any reference herein to an IC, IC chip, or chip is (more broadly speaking) a reference to any such semiconductor device.

FIG. 2 shows an example flow diagram of an IC design and locking process 200 that may be executed at IC design house and authenticator. The initial design of an IC is developed into an operational description, which herein includes an RTL description, gate-level description, or high-level description of the operation of the IC. In the example process 200, RTL descriptions 202 are used and enriched with support for on-chip TRNG (e.g., 102, 104 from IC 100) and a public-key cryptography controller (e.g., 114 from IC 100), such that each manufactured IC is able to establish its own random public key and random private key pair upon start-up. RTL data is provided to a locking decision process 204 that receives a cryptographic key, such as a public Master Key (MK-Pub) from an external source, such as the IP rights holder 205. The process 204 decides what kind of locking scheme to use and what modules to lock. The process 204 may then embed the enhanced RTL with the public Master Key (MK-Pub). The process 204 may embed by modifying the operational description in such a way that certain modules can use the MK-Pub. For example, a combinational locking mechanism can be used to add logic gates to the RTL description, preferably using minimal circuitry (see, e.g., FIGS. 3a and 3b). In other examples, logic gates may be removed from modules to embed the design for locking. In other examples, the embedding may including adding or removing wires or adding or removing lines of code in a high-level description. In any event, at this point, none of the newly added components are connected to the original logic of the chip.

To provide unlocking of an IC design, a logic synthesis and mapping process 206 produces a gate-level netlist from the embedded RTL (having the MK-Pub) using traditional logic synthesis and technology mapping. The process 206 then follows with circuit placement, such that now critical paths in the IC are known, and one may connect the anti-piracy logic without disturbing those paths. In other examples, the process 206 may occur before the process 204.

A process 208 then performs the actual combinational locking on the IC design from process 206. Combinational locking is performed on at least one module of the IC design and preferably one of the more important modules in the ICs. Such locking may be achieved, for example, by adding XOR gates on selected (non-critical) wires, with an added input control connected to the Common-Key register. In general, the process 208 adds a logical operator to one or more modules of the operational description, where that logical operator is coupled to at least one ‘normal’ input of that module and one other control input, such as one bit of memory for storing a key. An example implementation with the logical operator as an XOR gate is shown in FIG. 3b, and discussed further below. In some examples, the same logical operator (e.g., XOR) may be applied to each of the modules that is to be combinationally locked. In other examples, different logical operators may be used for different modules. In general, however, it is desired to have the control input result from a key that can validate the module by setting the control input to the desired value. In examples of more complex logical operators used to lock modules, the control input may be a multiple-bit control word applied over numerous inputs to the logical operator to control operation of the module.

Additionally, there are many ways to implement the XOR and XNOR logical operators for locking modules. For example, the gates may be explicitly added to the circuit, or the gates may be created by merging with nearby gates on the IC or by replacing parts of a circuit of with logically equivalent subcircuits, e.g., by rewriting the module entirely into a new circuit with the XOR or XNOR locking gate operation.

Further still, for some simple circuits XOR-based locking may not provide appropriate enough protection, in which case specialized locking techniques may be used, such as bus-locking, as described in co-pending application entitled “Protecting Hardware Circuit Design by Secret Sharing,” filed Mar. 9, 2010 (claiming the benefit of U.S. Provisional Application No. 61/158,716) and having U.S. application Ser. No. 12/720,628, and incorporated herein in its entirety.

Once the process 208 embeds the logical operators to lock the one or more modules, the process 208 produces a Common-key (CK) and sends CK to the IP rights holder 205 so that it can function as an authenticator, in response to later communications with the fabrication or other third party facility. When the correct CK appears at the IC the resulting circuit is converted to operate equivalently to the original IC design. Otherwise, the circuit's behavior is altered, as if stray inverters were placed on selected wires. Process 208 preferably generates the CK at random, so as to prevent it from being stolen earlier. After the locking has occurred at 208, routing and other physical optimizations then proceed as normal by process 210, followed by manufacturing.

FIGS. 3a and 3b illustrate an example implementation of a combinational locking technique as may be executed by the block 208 on a module of an RTL description. FIG. 3a illustrates a general half adder forming a module 300 in an RTL description. The half adder receives binary inputs A and B and produces a sum signal, S, and control signal, C. The half adder is shown for examples purposes, as any suitable logic block may be used instead for combinational locking.

FIG. 3b illustrates the half-adder 300′ with a combinational locking scheme added thereto. A control input signal, e.g., CK_{bit}, has been added as an input to an XOR 302 gate which also receives input A and which controls operation of the half-adder 300′. When the proper control input signal, e.g., CK_{bit}=0, is provided to the circuit 300′, the circuit 300′ reduces to the original circuit 300 of FIG. 3a and thus operates properly as a half-adder. If the control input signal indicates an improper value, e.g., CK_{bit}=1, then the XOR gate functions as an inverter and spoils the original circuit by introducing logical error into the module.

The control input signal for a particular module may be a single bit of the CK, i.e., CK_{bit}. Typically, the CK will be many bits long (take k as the number of bits), and will be used to unlock k logical operators, or gates, combinationally locked into the IC, where each bit of CK is to unlock a different one of the k gates. For example, if the process 204 determines than a 16 word key would be sufficient to protect an IC, given its size, etc., then the locking scheme from process 204 would identify the need for a 16 bit CK which means that 16 modules of the IC will need to be locked by the process 208. The CKbit value discussed for FIG. 3b would be one of those 16 bits.

FIG. 4 illustrates a process 400 for fabrication and activation of an IC. A fabrication process 402 receives the IC layout files (e.g., GDS II database file format data) from the router/communications controller 210 in FIG. 2. The IC are fabricated through known processes, such as described generally above and are packaged via the process 402. Each IC goes through an initial power-up process 404, from which each IC establishes a pair of private and public Random Chip Keys (RCKs) as indicated in process 406. The public and private key pair may be constructed by the public key cryptography controller 114, and may depend on random bits, but typically their construction is established using specific algorithms, as opposed to the common key which typically is generated without restriction. For example, the public and private key pairs may be determined in part by bits randomly determined using at least one of timing fluctuations, power fluctuations, or other fluctuations in physical parameters of the IC. In some examples, the RCKs are stored by being burned into electrically-programmable fuses, e.g., the Electronic Fuse Unit (EFU) in Sun's NIAGARA 2 processor, to prevent multiple activation attempts. To activate an IC, the fab executing the process 400 must establish a secure link with an authenticator, such as the holder of IP rights 205, and transmit the public RCK-Pub 408 to the authenticator. Preferably, this is required for each IC that is being activated, as each IC will have its own RCK pair. The transmission to the IP rights holder is authenticated using the fab's private key.

In response, at 410 the authenticator sends an Input Key (IK), which represents CK encrypted with MK-Pri and RCK-Pub. Using RCK-Pub to encrypt communications makes statistical attacks against MK-Pri more difficult. The resulting IK can be additionally encrypted using the fab's public key so that only the fab can receive it. When entered into the IC, at 412 the IK is decrypted using RCK-Pri and MK-Pub, which also authenticates the IK as being sent by the holder of IP rights 205. Upon decryption, CK is produced at 414, which unlocks the IC and facilitates testing at 416. After that, the chip can be sold.

If the IK is not properly authenticated then the process 400 stops at 412. CK cannot be recovered and the locked modules of the IC will not operate properly. The stoppage can result because of incorrect IK keys being received by the IC, and/or because of a communications error, such as incomplete keys. Stoppage can also occur during some possible cryptographic attacks, e.g., someone trying all possible IK combinations or trying many keys at random. That is, in some examples the block 412 may include a cryptographic attack protocol. If that protocol is in a normal state, the block 412 is allowed to pass control to the block 414 if the IK is valid. If however that attack protocol identifies an abnormal condition, such as when threshold amounts of false IKs have been received, then the block 412 passes control to block 416 where the IC is maintained in a lock state, or in some examples permanently disabled. For example, it may be important that block 412 limit the number of allowed attempts—if more than, say, three activation attempts fail, the chip should be rendered useless.

This protocol 400 is provided by way of example. It may be extended in numerous ways. For example, the fab could send to the IP rights holder time-stamp, serial number, or other data that the IP rights holder 205 also uses for authentication.

Further description is now provided regarding combinational locking of the RTL description modules, as may be performed by blocks 204-208 of FIG. 2. To protect a combinational circuit C(\vec{x}) with a k-bit key, a procedure that uses k new gates was developed. First, k wires {wᵢ} are selected and matched with the bits {y} of the key. For each selected wire wᵢ, its driver is disconnected from the sinks and either an XOR gate {wᵢ′=wᵢ⊕yᵢ} or XNOR gate {wᵢ=wᵢ ⊕̅yᵢ} is inserted, where yᵢ is the matched key bit and wᵢ is a new wire that drives all sinks previously driven by wᵢ. Either an XOR gate or an XNOR gate is preferred for combinational locking. The choice of XOR gate versus XNOR gate depends on the chosen value of the matched key bit. If the chosen value of yᵢ is 0, wᵢ′=yᵢ, otherwise wᵢ′=wᵢ ⊕̅yᵢ. Using the identity wᵢ ⊕yᵢ= w̅ᵢ ⊕̅yᵢ, one can replace an XOR gate with an XNOR gate and an inverter and, similarly, XNOR gates can be replaced by XOR gates and inverters.

In general, multiple key combinations are unlikely to unlock C′(\vec{x}, \vec{y}) because wᵢ⊕1=wᵢ ⊕̅0= w̅ᵢ, i.e., incorrect input key bits correspond to an inverter inserted into C(\vec{x}). Notable exceptions are circuits consisting entirely of XOR and XNOR gates, e.g., an XOR tree can be unlocked by 50% of all key combinations. However, this is not typical for circuits that use few XOR gates. Preferably C′(\vec{x}, \vec{y}) is to admit only a unique key combination, i.e.,

∃!\vec{y}∀\vec{x}C′(\vec{x},\vec{y}=C(\vec{x}) (1)

The “inverted E” symbol in (1) means that “there exists . . . ” the expression that follows. The inverted E with ! means “there exists a unique . . . ” So, when! is omitted one is requiring existence but not uniqueness. Thus, with ! omitted, this expression gives a Boolean equation for finding a working key combination. However, solving such an equation is harder than NP-complete, due to alternating quantifiers. In practical terms, this means that a SAT solver alone would be insufficient to find a key combination of non-trivial length, but Reduced Ordered Binary Decision Diagrams (ROBDDs) offer more appropriate tools. To this end, one can represent the operation = by constructing a miter circuit, then build the ROBDD of the miter, followed by universal and existential quantification using well-known ROBDD algorithms. The resulting ROBDD compactly represents all good key combinations by its paths, which can be counted in time proportional to the size of ROBDD. This formal method can be used to check the uniqueness of a key combination, but may also help forgers to discover the Common Key, if both C′(\vec{x}, \vec{y}) and C(\vec{x}) are available.

TABLE 1
Keys used by the example technique.

| | Transmit- | | Placed | | Working | IP |
|---|---|---|---|---|---|---|
| Key | ted? | RTL | design | Location | chip | holder |
| MK-Pri | — | — | — | — | — | ✓ |
| MK-Pub | § | ✓ | ✓ | ✓ | ✓ | ✓ |
| CK | § | — | — | ✓ | ✓ | ✓ |
| RCK-Pri | — | — | — | — | ✓ | — |
| RCK-Pub | ✓ | — | — | — | ✓ | ✓ |
| IK | ✓ | — | — | — | — | ✓ |

§ MK-Pub and CK are transmitted before mask creation and have smaller risk of interception.

The key used for combinational locking should be long enough to withstand brute-force attacks, which are defined as algorithms searching for a key that evaluate combinations and spend Ω (1) time per combination. For combinational locking, such attacks are additionally hampered by the NP-completeness of checking even one key combination. In practice, most incorrect combinations can be weeded out by scanning-in test patterns and comparing circuit responses to expected values. With a single scan chain, this will take time proportional to 2^{k} time for a k-bit key. However, multiple scan-chains can be run separately, and brute-forcing a (k₁+k₂)-bit key, whose k₁ and k₂ bits can be checked by different scan-chains, would take a time proportional to 2^{k1}+2^{k2} time rather than a time proportional to 2^{k1+k2.}

Definition 1 Given a circuit C′(\vec{x}, \vec{y}) locked with key \vec{y}, the effective length L (\vec{y}) of the key is log₂ of the expected number of combinations checked by best brute-force attack.

Theorem 1 Consider a circuit C′ (\vec{x}, \vec{y}) such that the key \vec{y} locks n independently-testable circuit modules and, for j=1 . . . n, exactly kⱼ bits of the key are dedicated to module j, while Gⱼ key combinations of 2^{kj} unlock module j. Then

[symbol]

(\vec{y})≦log₂(Σⱼ₌₁ⁿ2^{k}^{ⱼ}/Gⱼ)−1 (2)

In practice, having several good key combinations may be useful, e.g., to trace activation by different parties. However, this would decrease the effective length of the key. An L (\vec{y})>64 is therefore recommended.

The present techniques can protect ICs against piracy through unauthorized excess production and stolen masks. However, pirates may also steal RTL or gate-level netlists, layouts, as well as test-vectors and correct responses. Additional conceivable scenarios of piracy include reverse-engineering and modification of masks, production-scale modification of manufactured chips, and real-time observation of transient signals in successfully-activated chips. The present techniques can provide robust multi-layered defense against these considered attacks as well. In particular, we examined four categories of obstacles faced by attackers in their attempts to pirate ICs were consider.
Lack of information, e.g., not being able to obtain MK-Pri because it is never transmitted.
Computational complexity, e.g., not being able to break RSA-style public-key crypto-systems.
Technological barriers, e.g., not being able to reverse engineer the active layers of 45 nm ICs or masks.
Financial barriers, e.g., not being able to invest amounts larger than expected revenue from piracy.

To break the proposed IC protections by obtaining keys and without modifying masks or chips, it would be necessary to obtain RCK-Pub (the public random chip keys) for each chip, as well as MK-Pri (the private master key) and CK (the common key). While these three keys lead to IK, none of them is present in RTL or synthesized gate-level netlist, while RCK-Public and MK-Pri are not present in masks either. CK may conceivably be discovered by watching transient signals on an activated chip, but for 45 nm chips that would require very sophisticated technology. On the other hand, computational attacks seeking CK would require gate-level netlists for both C(\vec{x}) and C′(\vec{x}, \vec{y}), as well as astronomical amounts of time. Even if CK is discovered by pirates, and if they manage to read off RCK-Pub from each chip, having a full understanding of all masks and full access to each IC will not reveal MK-Pri, which is guaranteed by RSA-style public-key cryptography.

In some examples, the present techniques are able to provide multi-layered protection by using two assumptions: (i) cryptographic security of RSA-like public-key crypto-systems, as well as (ii) good statistical properties of TRNGs or chip IDs, and their resilience to attacks (the randomness of RCK). Additionally, proper selection of CK ensures a limited number of good key combinations, and defeats brute-force and formal-methods attacks.

From these, a few propositions endemic to some examples follow. Proposition 1-RCK-Public and MK-Public do not reveal information about their private counterparts. Proposition 2—Knowing CK, all public keys and both RCKs is insufficient to generate IK (irreversibility of PKC). Proposition 3—There are as many good CKs as good IKs. Proposition 4—Good IKs are as random as RCKs. Additional properties of example techniques hold when forgers cannot modify masks or ICs (but may have access to source files). Proposition 5—Different ICs nearly always have different RCKs. Proposition 6—Knowing a good CK is not sufficient to unlock multiple chips. Proposition 7—Different chips nearly always have different IKs. Eavesdropping on data exchanged during activation of a chip will not reveal IKs for other chips. Proposition 8—A chip can only be unlocked by entering an appropriate IK.

As pointed out above, a full understanding of masks, intercepting all communications, and even inspecting all signals in a successfully activated chip is not sufficient to break the present techniques. In the context when masks and chips cannot be modified by the forger, stealing RTL or gate-level netlists does not give much help either. Security can be further improved if chip-activation data are additionally encrypted by the fab, offering stronger cryptography that can be changed on demand. This also hampers man-in-the-middle attacks and denial-of-service attacks, where spurious activation data are sent to the holder of IP rights. Additionally, better traceability to fab will encourage better physical security.

One of the most serious types of attacks is the theft of CK and MK-Pri from the holder of IP rights—it is almost tantamount to the theft of IP rights and allows the pirates to produce IKs. As a countermeasure, the present techniques can be reinforced with Fab Keys. For example, FK-Public can be embedded in RTL, while FK-Private can be held by the fab and be required to produce the IK. This way, a pirate not associated with the fab will be unable to unlock chips.

Without access to MK-Pri, the pirates must modify chips or masks. Focused Ion Beam (FIB) would be too slow for production, but a full understanding of masks and the ability to arbitrarily change them gives the pirates an upper hand, at least in principle. Once they discover CK, they can hardwire it, bypassing input pins, TRNG and PCK hardware. However, this scenario is unlikely because, at 45 nm and below, masks are much harder to read than the actual shapes on the chip, due to Resolution Enhancement Techniques (RET). Scanning the actual shapes in silico is even harder, and the investment required for this may not pay off because pirated chips sell at a lower cost, often at low volumes.

We evaluated the present techniques in terms of their overhead and impact on traditional design flows and the difficulty of inserting the XOR gates that implement CKs. We also analyzed the effectiveness of formal and brute-force attacks.

Component overhead includes: (i) additional pins to enter IK, (ii) additional gates and wires to implement combinational locking, (iii) true random number generator (TRNG), (iv) hardware for public-key cryptography (RSA). Since the majority of the chip remains dormant until activation succeeds, an existing pin can be multiplexed to enter IK using a proper data serialization protocol. The combinational locking used herein does not affect critical path delays. It requires orders of magnitude fewer gates and wires than available on ICs, making its area and power overhead minor. A single TRNG is required, and existing TRNGs are rather small (0.036 mm² in 130 nm). RSA can be implemented with fewer than 10,000 2-input gates. RSA can also be turned off after activation (no power overhead) and does not affect critical paths (no delay overhead). Sun's NIAGARA 2 processor implements RSA in each of its 8 cores, with area overhead below 1%.

The present techniques may be implemented in various examples that do not require significant change from normal verification and testing flows. Indeed, test vectors developed for the original circuit remain valid after proposed changes because the unlocked IC behaves just like the original IC. Traditional verification techniques can be applied similarly. While the insertion of XORs during CK embedding is a relatively simple step, it can also be verified using SAT-based equivalence checking.

We develop two methods for counting the number of valid CKs in a circuit when XOR gates have been inserted. The first method is a formal technique that builds Equation 1 using ROBDDs and solves for all valid CKs. The second method is a brute-force approach that tries every possible CK and checks equivalence with the original circuit using ROBDDs. Both techniques were implemented in C++ code and using the CUDD ROBDD.

We evaluated the two techniques by inserting XOR gates into combinational circuits at random and counting valid CKs. All experiments were performed on a 2.4 GHz Opteron processor with 8 GB of RAM. Table 2 shows results of both techniques on two ALU circuits c880 and c3540 from the ISCAS'85 suite. The brute-force method was more efficient than the formal method on c880. In all cases, the formal method uses more runtime and memory. On c3540, brute-force is more memory efficient, but requires more runtime than the formal method. For 24-bit and larger keys, runtime for the formal method grows nearly exponentially, making it infeasible as an attack on the present techniques.

We also observed that inserting XOR gates randomly (e.g., the block 208) produces relatively few duplicate keys. For up to 32 bits on the c3540-benchmark, the valid key is unique. On the c880 benchmark, 4 of 2³² key combinations are valid, which only reduces the effective bit length by 2. For a 64-bit key in c880 to be breakable in less than 1 year, more than 2²⁰ key combinations would need to be valid. According to our experiments on these and the remaining ISCAS'85 circuits, such an explosion in the number of valid keys is highly unlikely. If an attacker parallelized the brute-force method with 10,000 times our resources, considering duplicate keys, it would still take 100 years to find a valid 64-bit key on c880. In our experiments, random insertion of XOR gates to as many as ⅛ of the gates did not produce many duplicate keys. Therefore, our suggested key length of 64 bits can be supported by most circuits with 500 gates, as well as by many smaller circuits.

TABLE 2
Counting the number of valid Common Keys for randomly inserted
XOR gates on the c880 and c3540 ISCAS'85 circuits.

| c880 (60 in, 26 out, 383 gates) | | | | C3540 (50 in, 22 out, 1669 gates) | | | |
|---|---|---|---|---|---|---|---|
| Common Key | | Runtime (sec) | | Common Key | | Runtime (sec) | |
| bits | #valid | formal | bruteF | bits | #valid | formal | bruteF |
| 12 | 1 | 128 | 1 | 12 | 1 | 94 | 66 |
| 13 | 1 | 737 | 1 | 13 | 1 | 116 | 75 |
| 14 | 1 | 195 | 1 | 14 | 1 | 148 | 186 |
| 15 | 2 | 555 | 2 | 15 | 1 | 250 | 258 |
| 16 | 2 | 3291 | 2 | 16 | 1 | 298 | 413 |
| 17 | 2 | 584 | 4 | 17 | 1 | 310 | 608 |
| 18 | 2 | 383 | 9 | 18 | 1 | 382 | 1060 |
| 19 | 2 | 868 | 15 | 19 | 1 | 519 | 2008 |
| 20 | 2 | 5375 | 29 | 20 | 1 | 369 | 2296 |
| 21 | 4 | >24 hrs | 60 | 21 | 1 | 701 | 5562 |
| 22 | 4 | 6670 | 117 | 22 | 1 | 408 | 11560 |
| 23 | 4 | 3905 | 230 | 23 | 1 | 839 | 16907 |
| 24 | 4 | 26008 | 462 | 24 | 1 | 5560 | 35015 |
| 32 | 4 | >72 hrs | >36 hrs | 32 | 1 | 150889 | >3 mnths |

| | | | | | |
|---|---|---|---|---|---|
| 64 | ~16 | >10⁶ years | 64 | ~4 | >10⁶ years |

Trends on the remaining ISCAS'85 circuits are similar. Data for 64-bit keys are estimated.

The disclosed approaches to defeating piracy of ICs render theft unprofitable by making the majority of attacks computationally infeasible. This is accomplished through a novel low-overhead combinational IC-locking system and a IC-activation protocol based on public-key cryptography. Circumventing our methodology without modifying the masks or ICs is very difficult because of the strong security guarantees provided by public-key cryptography. On the other hand, production-scale modification of fabricated ICs is infeasible today, and especially so for advanced technology nodes. Mask modification and other related scenarios appear to require unacceptably high investment, which may not be justified by revenue from pirated ICs. To this end, we note that pirated ICs are normally late to market, while enjoying smaller volumes and smaller margins than original ICs. Additionally, pirates cannot advertise openly and must justify higher risk by higher margins. This limits pirates' investment and makes it nearly impossible to justify NRE costs or gradually ramp up yield on an alternative fab.

The present techniques may be applied to modern FPGAs with bitstream encryption, introduced by Xilinx in 2001, by locking combinational cryptographic circuits.

In addition to actively preventing piracy (active hardware metering), the present techniques may also facilitate passive hardware metering by requiring serial numbers to be transmitted during chip activation.

Disclosed herein are comprehensive techniques to prevent piracy of integrated circuits. They require that every chip be activated with an external key, which can only be generated by the holder of IP rights, and cannot be duplicated. The techniques are based on (i) automatically-generated chip IDs, (ii) a novel combinational locking algorithm, and (iii) innovative use of public-key cryptography. Testing and evaluation demonstrates the additional overhead on circuit delay and power is negligible, and the standard flows for verification and testing do not require change. In fact, major required components have already been integrated into several chips in production. More formal methods of evaluating the combinational locking and computational attacks were used with success as well, demonstrating strong resistance to various piracy attacks.

The foregoing techniques for hardware based IC piracy protection can be deployed in any number of applications. The advantage of requiring an external IP rights holder or some other authenticator to activate the integrated circuit allows manufactures to more readily deploy activatable (i.e., locked) ICs into the consumer supply chain, pushing activation in some instances from the testing stages described above to the point-of-sale stage. For example, compatible ICs could be installed in products where consumers are traditionally given the option to purchase additional features, if desired. With automobiles, for example, the electronic side of the drive train control may include activatable circuitry having a particular type of stability control. If the user does not wish to purchase such circuitry, then that functionality of the underlying ICs is not activated and the customer will be unable to activate it themselves, given the robustness of the protocols described hereinabove. If instead, the consumer purchases the stability control, then the dealer could activate that control at the point-of-sale through the above described, encrypted techniques. In either case, the manufacturer is aided by having a single circuit assembly process, because now the same stability control enabling ICs can be used regardless of whether the functionality will ultimately be purchased. Also, the dealer and consumer are aided, because conceivably any activatable module of an IC could be activated at a later date, for example after the initial purchase if the consumer wants to later upgrade. This could lead to further revenue to the dealer and manufacturer.

An IC in an automobile is described, however it will be appreciated that these advantages could be implemented into any consumer product having an IC. Merely by way of example, these include cellular telephones, personal data assistants, person computers, digital media players, televisions, disc-based media players, navigational systems, digital cameras, and the like.

The above techniques discuss using random generators or generating schemes to create keys, whether it be the common or the public and private keys. Random generation, however, is not required. Instead these keys may be generated by deterministic processes, such as by using a pseudorandom number generator. These generation processes include using some known data values for key generation, for example the serial number of an IC. Any suitable key generator process capable of providing sufficient protection may be used. Furthermore, multiple processes can be combined together to generate such keys.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. A method for locking an integrated circuit, the method comprising:
embedding an operational description of the integrated circuit design with a cryptographic key supported by a cryptographic protocol, where the integrated circuit is capable of establishing a public key and a private key pair upon start up; and
locking at least one module of the integrated circuit by applying to the at least one module a logical operator having a control signal input, where the logical operator is for unlocking the at least one module in response to the control signal input having a valid value and where the logical operator is for maintaining locking of the at least one module in response to the control signal input having an invalid value.

2. The method of claim 1, wherein the operational description is a register transfer level (RTL) description, the method further comprising:
developing a gate-level netlist from the embedded RTL description; and
locking the at least one module of the integrated circuit based on the gate-level netlist.

3. The method of claim 1, wherein the operational description is a gate-level description.

4. The method of claim 1, wherein the operational description is a high-level description.

5. The method of claim 1, further comprising the integrated circuit generating a common key that includes the valid value of the control signal input.

6. The method of claim 5, wherein the common key is randomly generated.

7. The method of claim 5, wherein the common key is generated deterministically.

8. The method of claim 5, wherein the common key is produced by a pseudorandom generator or from a serial number.

9. The method of claim 5, wherein the common key has a bit length of at least 64 bits.

10. The method of claim 1, wherein upon start-up the integrated circuit establishes the public key and the private key through a random process.

11. The method of claim 10, wherein public key and the private key are established using at least one of timing fluctuations, power fluctuations, or other fluctuations in physical parameters of the integrated circuit.

12. The method of claim 1, wherein upon start-up the integrated circuit establishes the public key and the private key deterministically.

13. The method of claim 12, wherein the public key and the private key are established by a pseudorandom generator or from a serial number.

14. The method of claim 1, wherein the integrated circuit is an application specific integrated circuit, System-on-a-chip, microprocessor, digital signal processor, graphics processing unit, central processing unit, network processor, embedded processor, or a direct memory access circuit.

15. The method of claim 1, wherein the logical operator applied to the at least one module includes an XOR gate or XNOR gate.

16. A method of activating at least one module on an integrated circuit, the method comprising:
the integrated circuit establishing a random public key and private key pair upon start up;
transmitting the random public key to an authentication source for the integrated circuit;
the authentication source sending to the integrated circuit an input key in response to receipt of the random public key, wherein the input key represents a common key for the integrated circuit and is encrypted with a private master key of the authentication source and with the received random public key;
the integrated circuit decrypting the input key using the random private key and a public master key previously received at the integrated circuit to authenticate the input key as being received from a valid authentication source; and
in response to the authentication of the input key, producing a common key that activates the at least one module on the integrated circuit.

17. The method of claim 16, further comprising establishing the random public key and the random private key using at least one true random number generator corresponding to the integrated circuit.

18. The method of claim 16, further comprising establishing the random public key and the random private key using at least one pseudorandom generator corresponding to the integrated circuit.

19. The method of claim 16, wherein the common key has a bit length of at least 64 bits.

20. The method of claim 16, wherein the input key has a bit length of at least 64 bits.

21. The method of claim 16, further comprising the authentication source randomly establishing the input key.

22. The method of claim 16, further comprising storing the random public key and the random private key pair in the integrated circuit.

23. The method of claim 16, wherein the integrated circuit is an application specific integrated circuit, System-on-a-chip, microprocessor, digital signal processor, graphics processing unit, central processing unit, network processor, embedded processor, or a direct memory access circuit.
